(19) United States
(12) Patent Application Publication
(10) Pub. No.: US 2016/0149910 A1
(43) Pub. Date: May 26, 2016

(54) MANAGING SOFTWARE KEYS FOR NETWORK ELEMENTS

(71) Applicants: Ronald David Luque, Plano, TX (US); Jimmy Goodwin, Allen, TX (US)

(72) Inventors: Ronald David Luque, Plano, TX (US); Jimmy Goodwin, Allen, TX (US)

(21) Appl. No.: 14/550,427

(22) Filed: Nov. 21, 2014

(51) Int. Cl. H04L 29/06

(52) U.S. Cl. CPC H04L 63/0876; H04L 63/061; H04L 63/045

(57) ABSTRACT

Methods and systems for managing software keys include distributing software keys from a vendor to a customer key manager at a secure customer network that includes network elements comprising a transport network operated by a customer. Responsive to a provisioning event involving a network element, the network element may request a software key from the customer key manager for a network service associated with the provisioning event. The customer key manager may manage the software keys issued to network elements within the secure customer network. The software key may be provided as a key file that may be encrypted.

### BACKGROUND

1. Field of the Disclosure

The present disclosure relates to communications systems and more specifically to managing software keys for network elements.

2. Description of the Related Art

A communication network may include network elements that route packets through the network. Some network elements may include a distributed architecture, wherein packet processing may be distributed among several subsystems of the network element (e.g., line cards). Thus, network elements may be modular and may include various subsystems or subelements, which may be represented as physical and logical entities. The physical entities included in a network element may refer to the network element, a shelf, a slot, a port, a channel or various combinations thereof. In addition to the physical hardware being represented as physical entities, network elements include software, such as drivers and other executable instructions, that use logical entities to represent corresponding physical entities.

Accordingly, network elements may be implemented using a number of different commercial products, including hardware and software products, that are purchased from a vendor and used by a customer for network operations.

### SUMMARY

In one aspect, a first method for distributing software keys to network elements is disclosed. The first method may include receiving, at a key manager, a request for a software key from a network element. The software key may be associated with a software license provided by a vendor for the network element. The first method may include validating that the software key is available for the network element and generating a key file including the software key. The key file may include a globally unique identifier associated with the network element. The first method may include recording, in a key repository accessible to the key manager, an indication that the software key was used in the key file. The first method may also include enabling the key file to be sent to the network element, and receiving a confirmation that the software key was used at the network element.

In another aspect, a second method for managing software keys at network elements is disclosed. Responsive to a provisioning event for a network service at a network element in a transport network, the second method may include determining that the network service is subject to a software license associated with the network element. The second method may include sending a request to a key manager for a software key associated with the software license. Responsive to the request, the second method may include receiving a key file including the software key. The key file may include a globally unique identifier associated with the network element. The second method may include validating that the software key is issued for the network element, and activating the software license for the network service.

Additional disclosed aspects for managing software keys for network elements include a system comprising a processor configured to access non-transitory computer readable memory media, an article of manufacture comprising non-transitory computer readable memory media storing processor-executable instructions, a network server, and a network element.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a block diagram of selected elements of an embodiment of a transport network;

FIG. 2 is a block diagram of selected elements of a control plane;

FIG. 3 is a block diagram of selected elements of a software key management architecture;

FIGS. 4A and 4B are flow charts of selected elements of a method for distributing software keys to network elements;

FIGS. 5A, 5B, 5C, and 5D are flow charts of selected elements of a method for managing software keys at network elements; and

FIG. 6 is a block diagram of selected elements of a network element system.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a hyphenated form of a reference numeral refers to a specific instance of an element and the un-hyphenated form of the reference numeral refers to the collective element. Thus, for example, device “12-1” refers to an instance of a device class, which may be referred to collectively as devices “12” and any one of which may be referred to generically as a device “12”.

As noted previously, network elements may be implemented using a number of different commercial products, including hardware and software products, that a vendor may supply to a customer purchasing the network element. A typical arrangement for delivering software products that are used with network elements involves simply delivering the software associated with the purchased hardware. In this case, the customer may be subject to an initial licensing fee (ILF) to obtain a right to use (RTU) the software products so obtained.

However, hardware products used in network elements may be enabled to provide various levels of performance or functionality that may differ greatly from one implementation to another. In many instances, software configuration of hardware elements is used to enable different levels of performance or functionality. As a result, a software licensing scheme based on ILF/RTU may offer less flexibility than is desired. For example, a vendor may keep price levels higher for hardware products based on a blanket functionality that the ILF/RTU software licensing supports, even though certain customers do not desire all of the blanket functionality that the corresponding hardware products are capable of. Thus, the ILF/RTU software licensing scheme may result in higher prices and fewer choices for customers purchasing network element equipment and associated software products.

Another issue with software licensing for network elements is network security in the telecommunications industry. Because network elements represent the infrastructure over which network services are delivered, access to network elements may be restricted by network operators or network administrators. For example, network elements may be prevented from accessing external networks, such as public networks or the Internet, including accessing online support provided by the vendor of a network element. As a result of the particular network security implications in the telecommunications industry, distribution of software licenses may involve particular architectural constraints that prevent typical subscription-based or online-based types of software distribution models and associated licensing schemes from being used.

In this context, the inventors of the present disclosure have discovered methods and systems for managing software keys for network elements. As will be described in further detail, methods and system are disclosed for distributing software keys to network elements and for managing software keys at network elements. The methods and system disclosed herein provide software licensing schemes with improved differentiation of network services supported by software licenses that are related to particular hardware capabilities of network elements and components included within network elements. In this manner, improved software licensing schemes may be used with network elements in a manner that is compatible with the technical capabilities of network elements and with the particular operational constraints faced by the telecommunications industry.

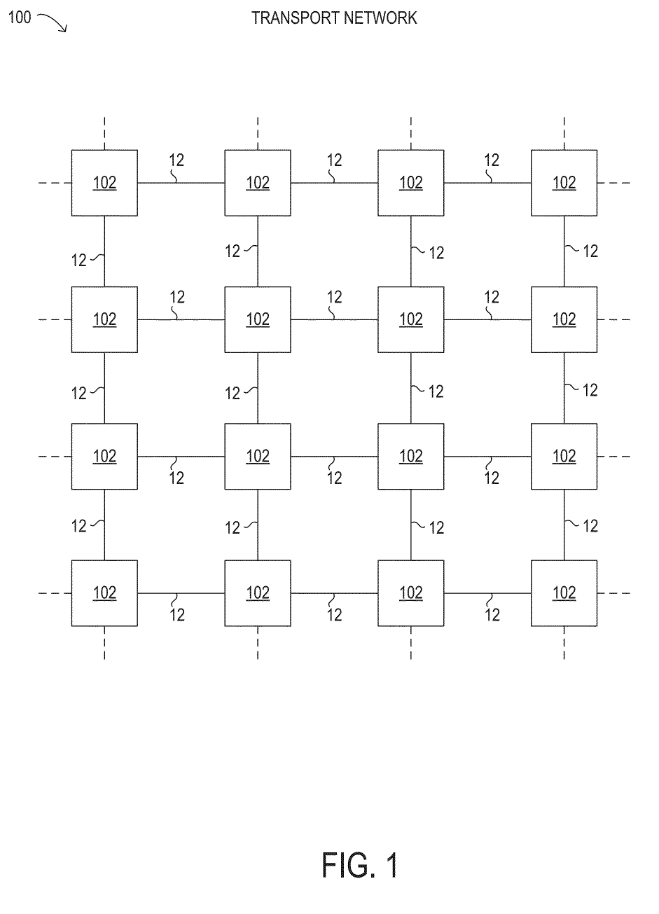

Referring now to the drawings, FIG. 1 is a block diagram showing selected elements of an embodiment of transport network 100. In various embodiments, transport network 100 may be an Ethernet network. Transport network 100 includes one or more transmission media 12 operable to transport one or more signals communicated by components of transport network 100. The components of transport network 100, coupled together by transmission media 12, include a plurality of network elements 102. In the illustrated transport network 100, each network element 102 is coupled to four other nodes. However, any suitable configuration of any suitable number of network elements 102 may create transport network 100. Although transport network 100 is shown as a mesh network, transport network 100 may also be configured as a ring network, a point-to-point network, or any other suitable network or combination of networks. Transport network 100 may be used in a short-haul metropolitan network, a long-haul inter-city network, or any other suitable network or combination of networks.

Each transmission medium 12 may include any system, device, or apparatus configured to communicatively couple network devices 102 to each other and communicate information between corresponding network devices 102. For example, a transmission medium 12 may include an optical fiber, an Ethernet cable, a T1 cable, a WiFi signal, a Bluetooth signal, and/or other suitable medium.

Transport network 100 may communicate information or “traffic” over transmission media 12. As used herein, “traffic” means information transmitted, stored, or sorted in transport network 100. Such traffic may comprise optical or electrical signals configured to encode audio, video, textual, and/or any other suitable data. The data may also be transmitted in a synchronous or asynchronous manner, and may be transmitted deterministically (also referred to as ‘real-time’) and/or stochastically. Traffic may be communicated via any suitable communications protocol, including, without limitation, the Open Systems Interconnection (OSI) standard and Internet Protocol (IP). Additionally, the traffic communicated via transport network 100 may be structured in any appropriate manner including, but not limited to, being structured in frames, packets, or an unstructured bit stream.

Each network element 102 in transport network 100 may comprise any suitable system operable to transmit and receive traffic. In the illustrated embodiment, each network element 102 may be operable to transmit traffic directly to one or more other network elements 102 and receive traffic directly from the one or more other network elements 102.

Modifications, additions, or omissions may be made to transport network 100 without departing from the scope of the disclosure. The components and elements of transport network 100 described may be integrated or separated according to particular needs. Moreover, the operations of transport network 100 may be performed by more, fewer, or other components.

During operation of transport network 100, an operator of transport network 100 may desire to purchase additional equipment or functionality, such as additional network elements 102, components for network elements 102, or expanded functionality of existing components of network elements 102. The additional equipment or functionality may be associated with a software license for the software that enables the additional equipment or functionality to operate in transport network 100. As will be disclosed in further detail herein, in addition to hardware components that may be purchased, software keys for software licenses may be purchased for network elements 102. The software keys may be distributed using methods disclosed herein for distributing software keys from a vendor to a customer purchasing a software license for a network element. The software keys may be managed using methods disclosed herein for managing software keys at a network element. The methods may include using a software key to ensure that a software license is used at a particular network element. Additionally, the methods disclosed herein for distributing software keys may be used to distribute software updates to specific network elements. For examples, at least certain functionality associated with a software update for a network element may be subject to a software license that depends upon a software key.

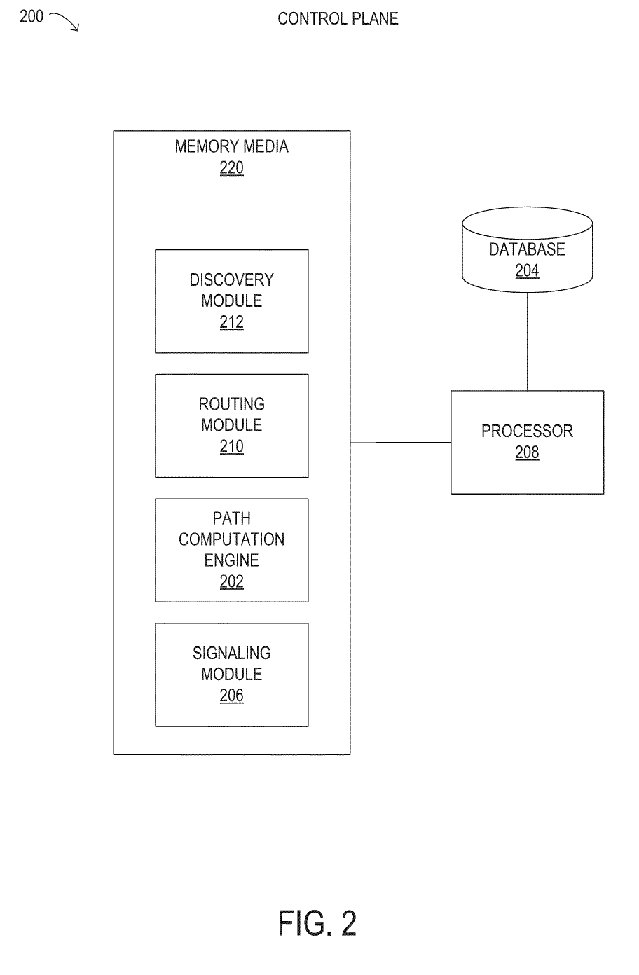

Referring now to FIG. 2, a block diagram of selected elements of an embodiment of control plane 200 for implementing control plane functionality in networks, such as, for example, in transport network 100 (see FIG. 1), is illustrated. A control plane includes functionality for network intelligence and control and comprises applications that support the ability to establish network services, including applications or modules for discovery, routing, path computation, and signaling, as will be described in further detail. The control plane applications executed by control plane 200 work together to automatically establish services within transport network 100, which may be at least in part an optical network. Discovery module 212 discovers local links connecting to neighbors. Routing module 210 broadcasts local link information to network nodes while populating database 204. When a request for service from transport network 100 is received, path computation engine 202 may be called to compute a network path using database 204. This network path may then be provided to signaling module 206 to establish the requested service.

As shown in FIG. 2, control plane 200 includes processor 208 and memory media 220, which store executable instructions (i.e., executable code) executable by processor 208, which has access to memory media 220. Processor 208 may execute instructions that cause control plane 200 to perform the functions and operations described herein. For the purposes of this disclosure, memory media 220 may include non-transitory computer-readable media that stores data and/or instructions for at least a period of time. Memory media 220 may comprise persistent and volatile media, fixed and removable media, and magnetic and semiconductor media. Memory media 220 may include, without limitation, storage media such as a direct access storage device (e.g., a hard disk drive or floppy disk), a sequential access storage device (e.g., a tape disk drive), compact disk (CD), random access memory (RAM), read-only memory (ROM), CD-ROM, digital versatile disc (DVD), electrically erasable programmable read-only memory (EEPROM), and/or flash memory; non-transitory media; and/or various combinations of the foregoing. Memory media 220 is operable to store instructions, data, or both. Memory media 220 as shown includes sets or sequences of instructions that may represent executable computer programs, namely, path computation engine 202, signaling module 206, discovery module 212, and routing module 210. In some embodiments, path computation engine 202, in conjunction with signaling module 206, discovery module 212, or routing module 210, may represent instructions or code for implementing various algorithms according to the present disclosure.

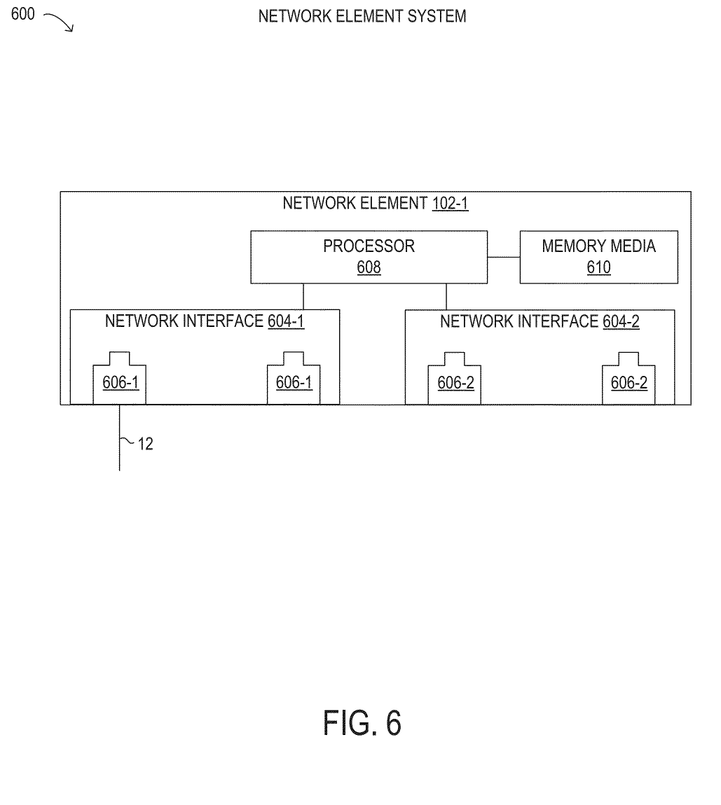

In certain embodiments, control plane 200 may be configured to interface with a person (i.e., a user) and receive data about the signal transmission path. For example, control plane 200 may also include or may be coupled to one or more input devices or output devices to facilitate receiving data about the signal transmission path from the user and/or outputting results to the user. The input and output devices (not shown) may include, but are not limited to, a keyboard, a mouse, a touchpad, a microphone, a display, a touchscreen display, an audio speaker, or the like. Alternately or additionally, control plane 200 may be configured to receive data about the signal transmission path from a device such as another computing device or a network element (see also FIGS. 1 and 6).

As shown in FIG. 2, in some embodiments, discovery module 212 may be configured to receive data concerning a signal transmission path in a network and may be responsible for discovery of neighbors and links between neighbors. In other words, discovery module 212 may send discovery messages according to a discovery protocol, and may receive data about the signal transmission path. In some embodiments, discovery module 212 may determine features, such as, but not limited to: media type, media length, number of components, type of components, data rate, modulation format of the data, input power of an optical signal, number of optical signal carrying wavelengths (channels), channel spacing, traffic demand, and network topology, among others, including various combinations thereof.

As shown in FIG. 2, routing module 210 may be responsible for propagating link connectivity information to various nodes within a network, such as transport network 100. In particular embodiments, routing module 210 may populate database 204 with resource information to support traffic engineering, which may include link bandwidth availability. Accordingly, database 204 may be populated by routing module 210 with information usable to determine a network topology of a network.

Path computation engine 202 may be configured to use the information provided by routing module 210 to database 204 to determine transmission characteristics of the signal transmission path. The transmission characteristics of the signal transmission path may provide insight on how transmission degradation factors may affect the signal transmission path. When the network is an optical network, the transmission degradation factors may include, for example: chromatic dispersion (CD), nonlinear (NL) effects, polarization effects, such as polarization mode dispersion (PMD) and polarization dependent loss (PDL), amplified spontaneous emission (ASE) and others, which may affect optical signals within an optical signal transmission path. To determine the transmission characteristics of the signal transmission path, path computation engine 202 may consider the interplay between various transmission degradation factors. In various embodiments, path computation engine 202 may generate values for specific transmission degradation factors. Path computation engine 202 may further store data describing the signal transmission path in database 204.

In FIG. 2, signaling module 206 may provide functionality associated with setting up, modifying, and tearing down end-to-end network services in transport network 100. For example, when an ingress node in the optical network receives a service request, control plane 200 may employ signaling module 206 to request a network path from path computation engine 202 that may be optimized according to different criteria, such as bandwidth, cost, etc. When the desired network path is identified, signaling module 206 may then communicate with respective nodes along the network path to establish the requested network services. In different embodiments, signaling module 206 may employ a signaling protocol to propagate subsequent communication to and from nodes along the network path.

In operation, control plane 200 may be used to provision network services on network elements. When a network service is provisioned at a network element by a network operator, control plane 200 may send a corresponding notification to the network element, which is referred to herein as a “provisioning event”. Thus, a network element may receive a notification that a provisioning event has occurred. The network element may be configured to respond to the provisioning event by configuring a software component to implement the provisioned network service. The software component may be associated with a logical entity, such as a shelf, a slot, a port, or a channel, while the logical entity may be implemented by a corresponding hardware component, such as a card or a port, included in the network element.

In certain instances, the provisioning event may thus involve configuration of a software component to change functionality at the network element according to the provisioned network service. The configuration of the software component may involve a software license, for example in association with the provisioned network service. As will be described in further detail herein, validation of the software license may be accomplished using a software key. The software key may be provided as a separate software product by the vendor, such as with a particular article number and a price, enabling the software key to be purchased and made available to the network operator. The network operator may implement a customer key manager for internally managing software keys on a secure network on which control plane 200 and network elements 102 are accessible. The customer key manager may thus store, or have access to, a customer key repository including software keys from the vendor. Then, when the network element receives an indication of the provisioning event and recognizes that the requested software license for the provisioned network service is subject to a software key, the network element may be provided the software key by the customer key manager. The software key may be included in a key file sent to the network element by the customer key manager. The key file may include a globally unique identifier for the network element. The customer key manager may manage various different software keys, including inventory, usage, and tracking with regard to network elements that have been issued software keys.

It is noted that the software licensing enabled by the use of software keys and key files, as described herein, may support different types of licensing models. For example, a software key may be used to enable a software license for a network service over a particular duration that expires when the duration is elapsed. In the case of a periodic or recurring (subscription-based) software license, control plane 200 (or the network element) may recognize that a software license is expiring and may generate (or request) a provisioning event to renew the software license for the network service. In some embodiments, the provisioning event occurs to obtain or renew the software license for the network service even when the network service is already operational on the transport network.

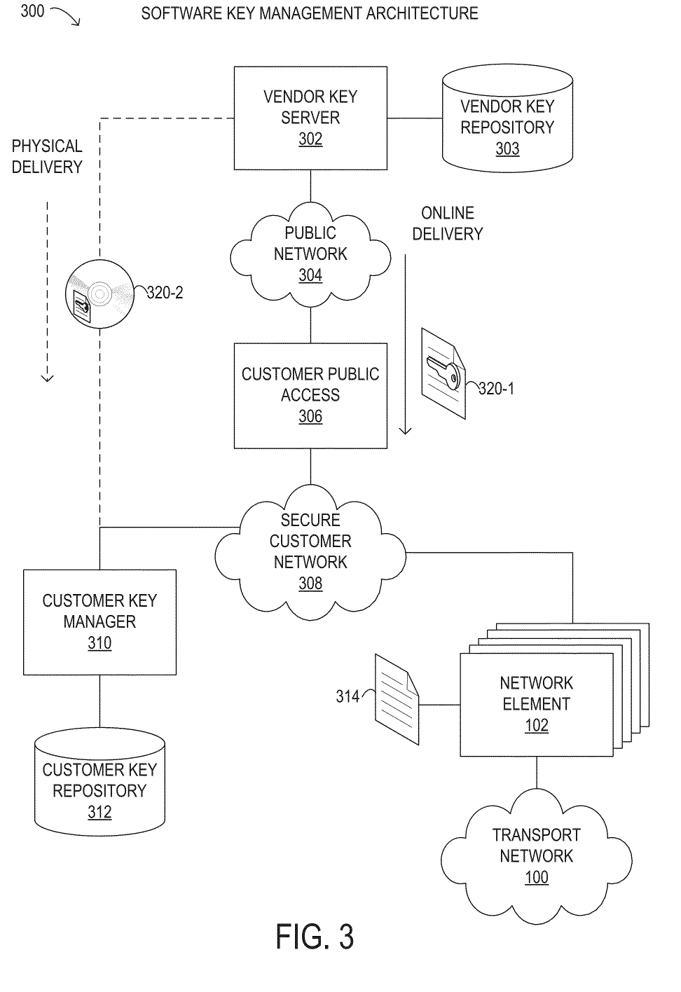

Referring now to FIG. 3, a block diagram of selected elements of an embodiment of software key management architecture 300 for managing software keys is illustrated. It is noted that software key management architecture 300 is a schematic representation and is not drawn to scale. In various embodiments, software key management architecture 300 may include fewer or more elements than depicted in FIG. 3. As shown, software key management architecture 300 includes elements operated by a vendor and elements operated by a customer who may be a network operator of transport network 100 (see FIG. 1). In software key management architecture 300, vendor key server 302 and vendor key repository 303 may represent vendor infrastructure for distributing software keys to a plurality of customers. In software key management architecture 300, customer public access 306, secure customer network 308, customer key manager 310, customer key repository 312, key file 314, network elements 102, and transport network 100 may represent customer infrastructure of a customer for managing software keys and operating transport network 100. In certain embodiments, the customer infrastructure may further include at least certain portions of control plane 200 (see FIG. 2), for example, for provisioning network services on network elements 102. In software key management architecture 300, public network 304 may represent a publicly accessible network, such as the Internet. It is noted that certain portions of public network 304 may be implemented by transport network 100 in particular embodiments.

In software key management architecture 300 of FIG. 3, vendor key server 302 and vendor key repository 303 may represent vendor infrastructure for distributing software keys to a plurality of customers. Vendor key server 302 is shown being accessible by public network 304, for example, via a website operated by the vendor. Public network 304 may be used by the customer for online delivery of software keys 320-1. For example, customer public access 306 may represent computing resources that are external to secure customer network 308, but that allow the customer to access vendor key server 302 via public network 304 to obtain online delivery of software keys 320-1. In this manner, the customer may procure and obtain software keys 320-1 using an online download transaction at customer public access 306. The customer may then introduce software keys 320-1 to secure customer network 308, for example, by manual transfer to customer key repository 312 using customer key manager 310.

In software key management architecture 300, vendor key server 302 may also be used for physical delivery of software keys 302-2 by generating the storage media that store software keys 302-2, such as compact discs (CDs) or digital video disks (DVDs), as non-limiting examples of storage media. Specifically, when the customer orders network element equipment, such as hardware or software components for use in a network element, the customer may order (or may be provided with) software keys 320-2 corresponding to software licenses for that particular order. After the order is processed at a back office of the customer (not shown), the ordered network element equipment may be physically delivered along with software keys 320-2, which are shown being physically delivered, for example on a storage media. Thus, software keys 320-2 represent physically delivered products provided to the customer. The customer may physically obtain software keys 320-2 and load software keys 320-2 manually onto customer key repository 312 using customer key manager 310, for example.

In various embodiments of software key management architecture 300, vendor key server 302 may be aware of contents of customer key repository 312 managed by customer key manager 310, even though secure customer network 308 may not generally permit online access to customer key manager 310 or network elements 102. For example, vendor key server 302 may track procurements and deliveries for the customer. In certain instances, customer key manager 310 may be enabled to send a message from within secure customer network 308 to vendor key server 302, for example, when software key 320 is allocated from customer key repository 312 for network element 102.

Thus, in software key management architecture 300, the customer may operate customer key manager 310 for managing software keys 320 across secure customer network 308. In various embodiments, customer key manager 310 may represent functionality provided by the vendor to the customer for use on secure customer network 308, such as a software program or a computer system configured with a software program. As described above, the customer may obtain software keys 320 using physical delivery or online delivery in a manner consistent with the network security provided by secure customer network 308. The customer may load software keys 320 onto customer key repository 312. Then, when network element 102 recognizes that a provisioned network service is subject to a software license, network element 102 may request software key 320 corresponding to the software license from customer key manager 310. Responsive to the request from network element 102, customer key manager 310 may first check whether software key 320 is available in customer key repository 312. When software key 320 is not available in customer key repository 312, customer key manager 310 may initiate procurement processes to obtain software key 320. When software key 320 is available in customer key repository 312, customer key manager 310 may generate key file 314 including software key 320 and may send key file 314 to network element 102, which may, in turn, upon receiving key file 314 with software key 320, proceed to activate the software license for which software key 320 is issued.

Furthermore, in software key management architecture 300, customer key manager 310 may associate software key 320 and key file 314 explicitly with network element 102. For example, customer key manager 310 may record in customer key repository 312 a globally unique identifier (not shown) for network element 102 in association with the software license. The globally unique identifier may be for network element 102 or for a particular hardware component or subcomponent included in network element 102 that is associated with the requested software license. In various embodiments, the globally unique identifier may be included in key file 314. In some embodiments, the globally unique identifier may be used to generate a public/private encryption key pair associated with network element 102. For example, customer key manager 310 may encrypt at least a portion of key file 314, such as software key 320, using a public key of the public/private encryption key pair of which network element 102 stores a private key. In this manner, key file 314 may be generated to be usable by network element 102 requesting software key 320, but not by other network elements. For example, network element 102 may check that key file 314 includes the same globally unique identifier as used internally by network element 102 and may not apply software key 320 included with key file 314 when a match is not detected. When using public/private encryption with key file 314, network element 102 may be alone in possession of the private key, such that other network elements are unable to decrypt key file 314 and obtain software key 320. It is noted that the globally unique identifier may include a Universal Serial Identifier (USI) in accordance with guidelines established by the Alliance for Telecommunications Industry Solutions (ATIS). In different embodiments, the globally unique identifier may include a processor identifier for a particular processor included in network element 102.

In software key management architecture 300, network element 102 may request software key 320 from customer key manager 310 for a software license. When software key 320 is not available from customer key repository 312, customer key manager 310 may respond to network element 102 with a key-declined indication. When network element 102 receives the key-declined indication instead of receiving software key 320, network element 102 may take various courses of action in different embodiments. In one embodiment, when network element 102 receives the key-declined indication, network element 102 may disable (or prevent from being enabled) the network service for which the software license was requested, thereby preventing provision of the network service. In another embodiment, when network element 102 receives the key-declined indication, network element 102 may enable the network service but may generate a network alarm indicating that the software license for the network service was not yet obtained. The network alarm may be any type of notification of a condition at a network element. In certain embodiments, the network alarm may include different types of notifications, such as electronic, acoustic, visual, etc. The network alarm may be distributed to various entities, including, for example, a network operator or a network administrator. In this manner, a software licensing scheme using software keys 320 may be implemented that does not disrupt operation of transport network 100. In particular embodiments, when network element 102 receives the key-declined indication and generates the corresponding network alarm, the network alarm may be repeated until the software license is obtain and software key 320 is provided to network element 102. In some embodiments, network element 102 may further increase a priority of the network alarm over a certain duration. After the duration has elapsed and the network alarms have been issued over the duration, network element 102 may then disable the network service.

In software key management architecture 300, network element 102 may be governed by software license terms for a plurality of network services offered by the vendor. The totality of the software license terms may represent a software policy for network element 102. The software policy may thus include the software license terms for each of the plurality of network services. The software policy may further specify additional actions taken by the network element in managing software licenses. For example, the software policy may govern particularities when network element 102 responds to a key-declined indication, such as an interval of the network alarms or the duration, as described above. The software policy may be provided to network element 102 in the form of a policy file (not shown) that is loaded onto network element 102 and which network element 102 refers to in response to provisioning events. Thus, in determining that a provisioned network service is subject to a software license associated with the network element, the network element may accessing the policy file at the network element to determine whether the network service is subject to the software license. Furthermore, the policy file may be generated and updated by the vendor. For example, a new policy file may be sent to the customer using the online delivery or physical delivery processes described above with respect to software keys. Then, the new policy file may be loaded onto the network element, and may replace a previous policy file, thereby updating the software policy, as desired by the vendor, at the network element.

Furthermore, software key management architecture 300, a provisioning event may be for de-provisioning a network service from network element 102. De-provisioning may involve removal of the network service or revocation or expiration of a software license associated with the network service. As with provisioning, de-provisioning may affect transport network 100, network element 102, or a subcomponent included in network element 102. Accordingly, when network element 102 detects that the network service has been de-provisioned, network element 102 may send a notification to customer key manager 310 that a software key for the de-provisioned network service is no longer in use. Then, customer key manager 310 may record an indication that the software key is no longer associated with network element 102. In certain embodiments, the software key may be returned to a key inventory for valid software keys, for example, in customer key repository 312. Then, the software key may be available for re-use by customer key manager 310, as desired.

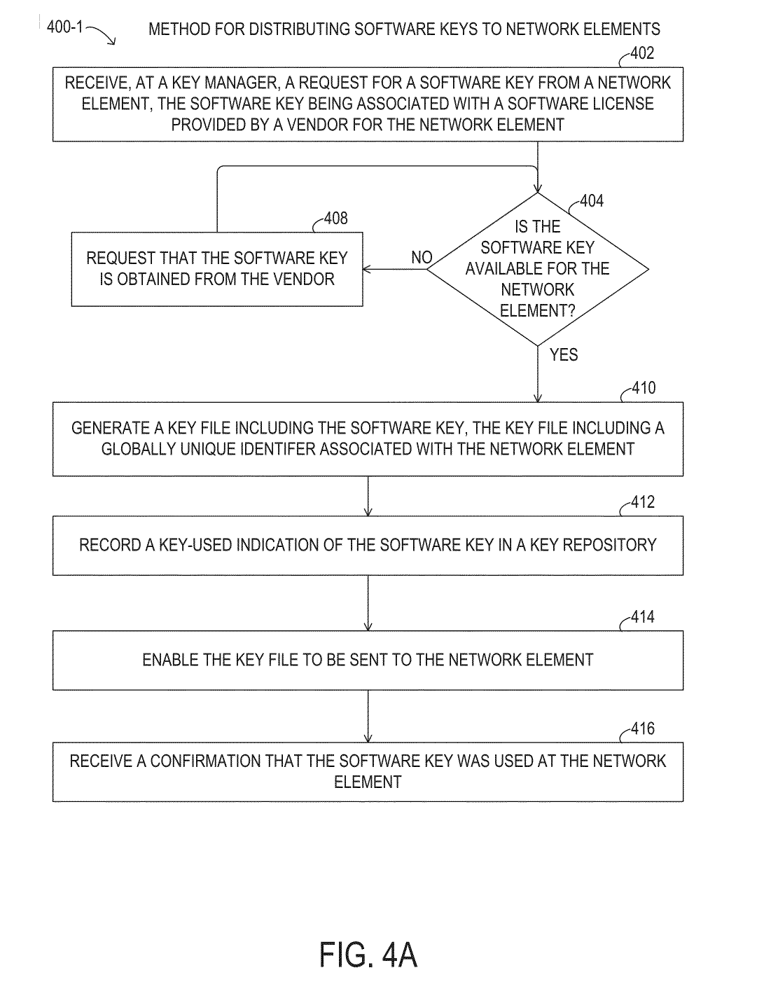

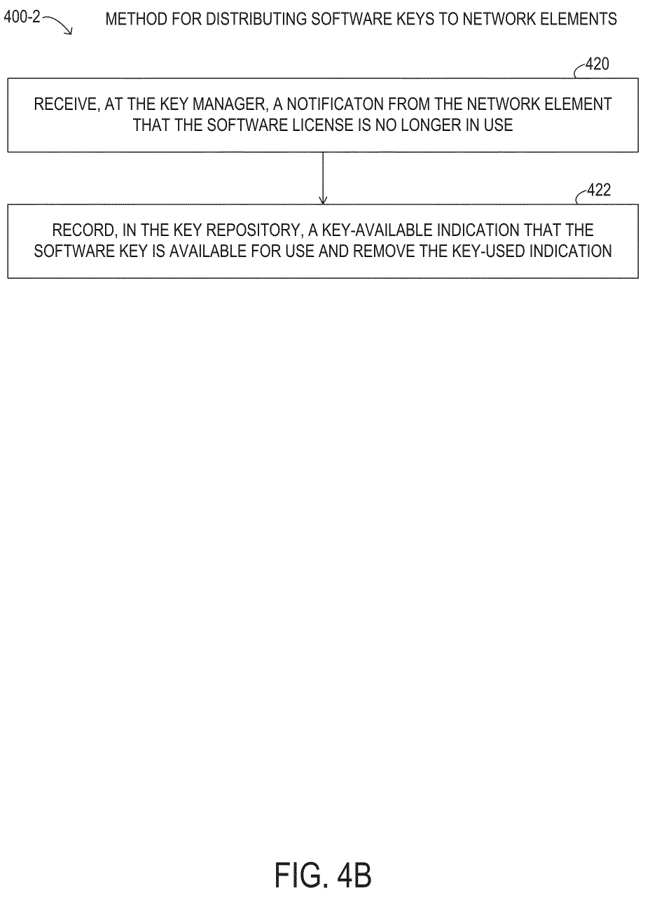

Referring now to FIG. 4A, a block diagram of selected elements of an embodiment of method 400-1 for distributing software keys to network elements, as described herein, is depicted in flowchart form. Method 400-1 may be performed by customer key manager 310 (see FIG. 3). It is noted that certain operations described in method 400-1 may be optional or may be rearranged in different embodiments.

Method 400-1 begins by receiving (operation 402), at a key manager, a request for a software key from a network element, the software key being associated with a software license provided by a vendor for the network element. The request in operation 402 may be received in response to a provisioning event for a network service at the network element. In method 400-1, the software license may involve licensing various types of network functionality that may be associated with a network service. For example, the software license may be selected from at least one of: a global license for the transport network, the transport network including the network element; a license for the network element; a license for a subcomponent of the network element; a license to increase data throughput at the network element; a license to increase a number of ports used at the network element; a license to introduce the network service at the network element; and a license to increase a number of instances of the network service used at the network element. Furthermore, the software license may be associated with various types of network services. For example, the software license may govern the use of network services selected from at least one of: a protection switching network service; a link access group network service; an optical unidirectional path-switched ring network service; a network service to use a wavelength selective switch; a network service to increase a number of ports at a wavelength selective switch; a network service to allow multi-traffic traffic identifiers per shelf of reconfigurable optical add drop multiplexer; a network service to increase a capacity of a card; a network service to increase a capacity of a shelf; a network service to increase capacity of a time-domain multiplexing switch; a network service to enable optical transport network switching; a network service to mix different optical transport networking cards within a shelf; a network service at an optical transport network control plane; and a network service to enable selection of revertive or non-revertive protection switching.

Then, in method 400-1, a decision may be made whether the software key is available (operation 404) for the network element. When the result of operation 404 is NO, method 400-1 may request (operation 408) that the software key is obtained from the vendor. The request in operation 408 may be sent to a back office associated with customer key manager 310 for procurement of the software key from the vendor. After operation 408, method 400-1 may loop back to operation 404 until the software key has been procured. When the result of operation 404 is YES, a key file including the software key may be generated (operation 410), the key file including a globally unique identifier associated with the network element. The globally unique identifier may be a USI. In some embodiments, operation 410 may include encrypting the key file. The key file may be encrypted in operation 410 using a public key of a public/private encryption key pair, where a private key of the public/private encryption key pair is associated with the network element. In certain embodiments, the globally unique identifier may be used to generate the public key and a private key comprising the public/private encryption key pair.

Then, an indication of the software key may be recorded (operation 412) in a key repository. As noted previously, customer key manager 310 may record information for software keys in customer key repository 312. In various embodiments, customer key repository 312 may represent a stockpile of software keys that are managed using customer key manager 310. When the software keys are procured, customer key manager 310 may add the newly available software keys to customer key repository 312. When software keys are issued to network elements, such as in method 400-1, customer key manager 310 may account for the issued software keys, for example, by reducing an inventory count for the particular software key. Also, customer key manager 310 may record an indication, such as the globally unique identifier, for each issued software key, thereby maintaining an inventory of issued software keys and network elements to which the software keys have been issued. Then, the key file may be enabled (operation 414) to be sent to the network element. In some embodiments, the key file is sent to the network element in operation 414. In other embodiments, the key file is made available for download by the network element in operation 414. Finally, a confirmation may be received (operation 416) that the software key was used at the network element. The confirmation in operation 416 may be received from the network element.

Referring now to FIG. 4B, a block diagram of selected elements of an embodiment of method 400-2 for distributing software keys to network elements, as described herein, is depicted in flowchart form. Method 400-2 may be performed by customer key manager 310 (see FIG. 3). It is noted that certain operations described in method 400-2 may be optional or may be rearranged in different embodiments. Method 400-2 may be performed after method 400-1 (see FIG. 4A).

Method 400-2 begins by receiving (operation 420), at the key manager, a notification from the network element that the software license is no longer in use. The notification in operation 420 may be received in response to a de-provisioning event for the network service at the network element. The notification in operation 420 may be a request by the network element to remove the software key. A key-available indication that the software key is available for use may be recorded (operation 422) in the key repository and the key-used indication may be removed. In this manner, an association for the software key with the network element may be removed and the software key may be made available for use by any network element.

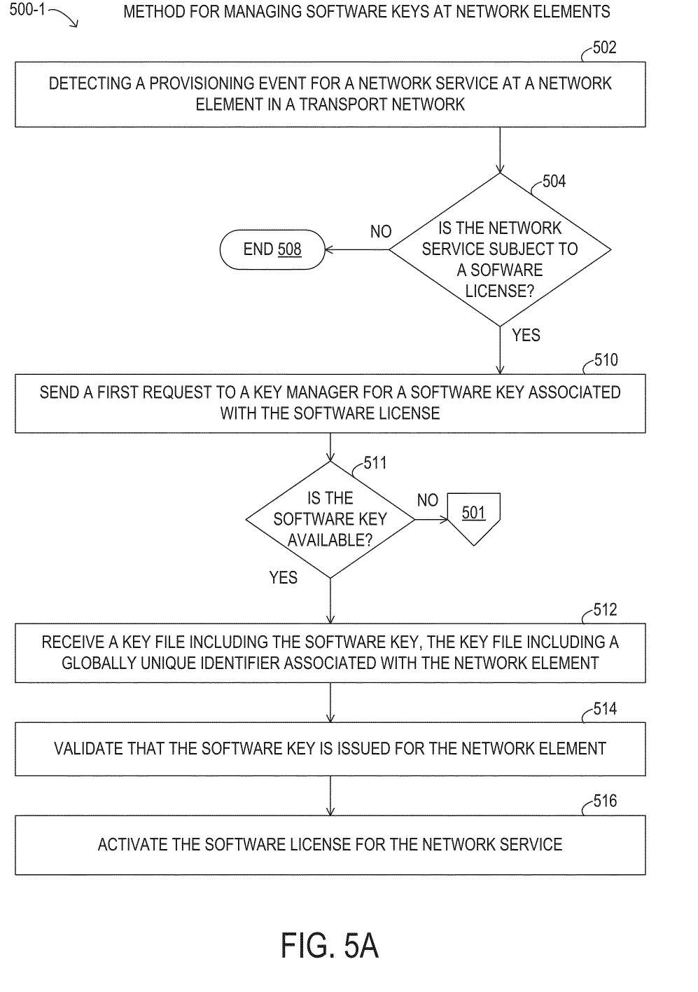

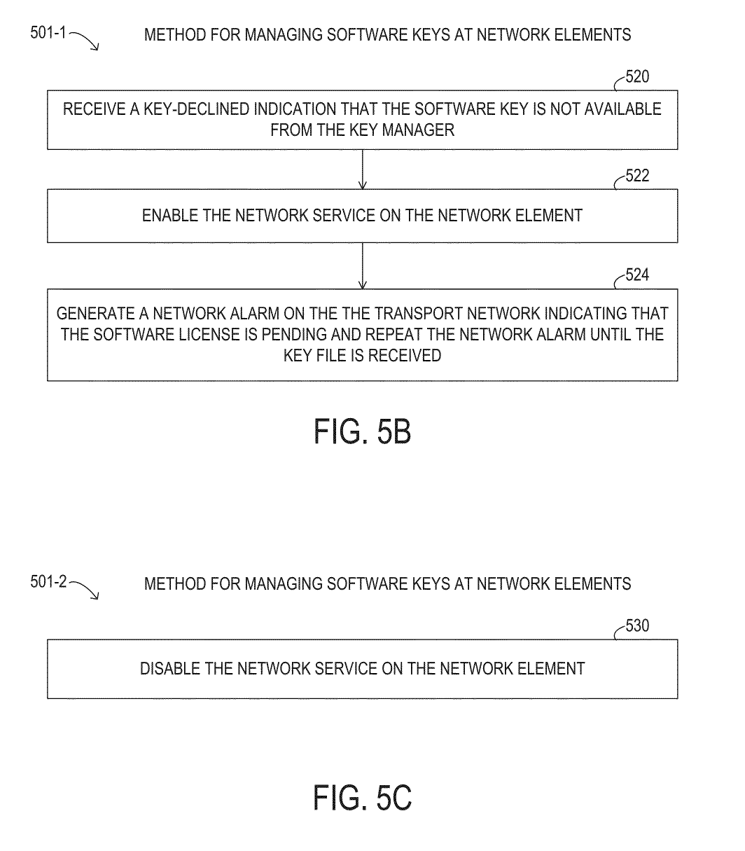

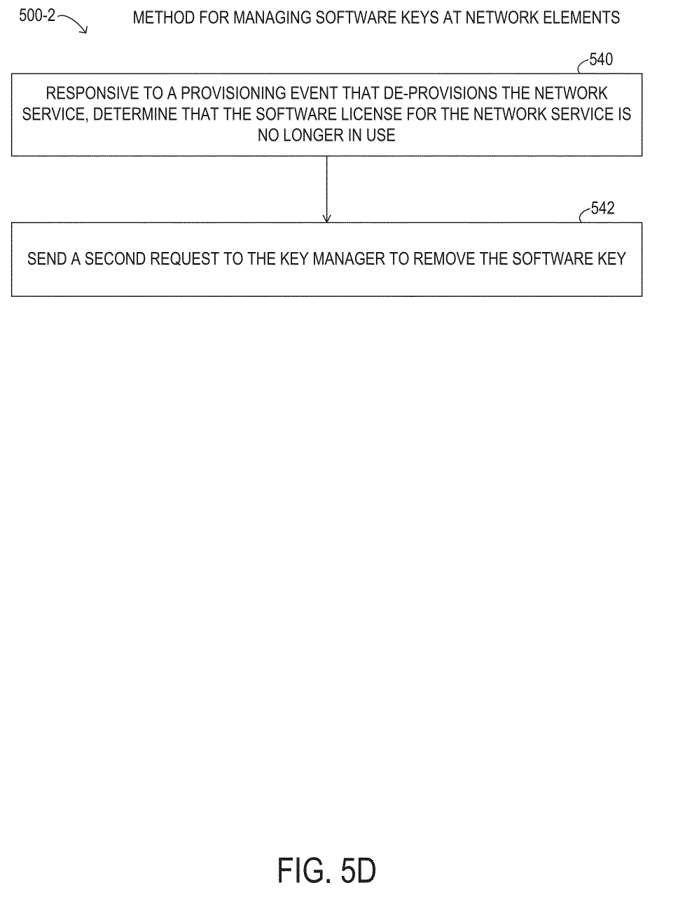

Referring now to FIG. 5A, a block diagram of selected elements of an embodiment of method 500-1 for managing software keys at network elements, as described herein, is depicted in flowchart form. Method 500-1 may be performed by network element 102 (see FIG. 6). It is noted that certain operations described in method 500-1 may be optional or may be rearranged in different embodiments.

Method 500-1 may begin by detecting (operation 502) a provisioning event for a network service at a network element in a transport network. The provisioning event in operation 502 may be performed using control plane 200, for example, in response to a provisioning request. Detecting the provisioning event in operation 502 may involve receiving a provisioning message from control plane 200. Then, a decision may be made whether the network service is subject (operation 504) to a software license. When the result of operation 504 is NO, method 500-1 may end (operation 508). When the result of operation 504 is YES, a request may be sent to a key manager for a software key associated with the software license. Then, a decision may be made whether the software key is available (operation 511). The decision in operation 511 may be based on a response from the key manager to the request in operation 510. When the result of operation 511 is NO, method 500-1 may proceed to method 501 (see FIGS. 5B and 5C). When the result of operation 511 is YES, a key file including the software key may be received (operation 512), the key file including a globally unique identifier associated with the network element.

Then, method 500-1 may validate (operation 514) that the software key is issued for the network element. In some embodiments, operation 514 may include comparing the globally unique identifier in the key file with globally unique identifiers for hardware components included in the network element. In some embodiments, operation 514 may include decrypting the key file. The key file may be decrypted in operation 514 using a private key of a public/private encryption key pair, the private key being associated with the network element. In certain embodiments, the globally unique identifier may be used to generate the private key and a public key comprising the public/private encryption key pair. Then, the software license may be activated (operation 516) for the network element. It is noted that operation 516 may be omitted when the software key is not validated in operation 514.

Referring now to FIG. 5B, a block diagram of selected elements of an embodiment of method 501-1 for managing software keys at network elements, as described herein, is depicted in flowchart form. Method 501-1 may be performed by network element 102 (see FIG. 6). It is noted that certain operations described in method 501-1 may be optional or may be rearranged in different embodiments. Method 501-1 may be performed when the result of operation 511 is NO (see FIG. 5A).

In method 501-1, a key-declined indication that the software key is not available from the key manager may be received (operation 520). The network service may then be enabled (operation 522) on the network element. The network service may be temporarily or provisionally enabled in operation 522 for a predetermined period or duration. A network alarm may be generated (operation 524) on the transport network indicating that the software license is pending and the network alarm may be repeated (operation 524) until the key file is received. The network alarm may be repeated for the predetermined period. During the predetermined period, a priority of the network alarm may be increased. When the key file is received during the predetermined period, method 501-1 may proceed to operation 512 in method 500-1. When the key file is not received by the time the predetermined period has elapsed, method 501-1 may continue to method 501-2.

Referring now to FIG. 5C, a block diagram of selected elements of an embodiment of method 501-2 for managing software keys at network elements, as described herein, is depicted in flowchart form. Method 501-2 may be performed by network element 102 (see FIG. 6). It is noted that certain operations described in method 501-2 may be optional or may be rearranged in different embodiments. Method 501-2 may be performed when the result of operation 511 is NO (see FIG. 5A). Method 501-2 may be performed after operation 524 (see FIG. 5B). In method 501-2, the network service may be disabled (operation 530) in the network element. The disabling of the network service in operation 530 may involve preventing the network service from being enabled.

Referring now to FIG. 5D, a block diagram of selected elements of an embodiment of method 500-2 for managing software keys at network elements, as described herein, is depicted in flowchart form. Method 500-2 may be performed by network element 102 (see FIG. 6). It is noted that certain operations described in method 500-2 may be optional or may be rearranged in different embodiments. Method 500-2 may be performed after operation 516 (see FIG. 5A). Responsive to a provisioning event that de-provisions the network service, method 500-2 may determine (operation 540) that the software license for the network service is no longer in use. A second request may be sent (operation 542) to the key manager to remove the software key. In this manner, the network element may remove the software key from any association with the network element.

Referring now to FIG. 6, a block diagram of selected elements of an embodiment of network element system 600 is shown. In network element system 600, network element 102-1 is represented as a particular embodiment of network elements 102 (see FIG. 1) for descriptive purposes. Network element 102-1, as shown, includes processor 608 and memory media 610, along with network interface 604-1 having ports 606-1 and network interface 604-2 having ports 606-2.

As depicted in FIG. 6, network element 102-1 includes processor 608 and memory media 610 that may store instructions executable by processor 608. As shown, memory media 610 may represent volatile, non-volatile, fixed, and/or removable media, and may be implemented using magnetic and/or semiconductor memory. Memory media 610 is capable of storing instructions (i.e., code executable by processor 608) and/or data. Memory media 610 and/or at least a portion of contents of memory media 610 may be implemented as an article of manufacture comprising non-transitory computer readable memory media storing processor-executable instructions. Memory media 610 may store instructions including an operating system (OS), which may be any of a variety of operating systems, such as a UNIX variant, LINUX, a Microsoft Windows® operating system, or a different operating system. It is noted that network interface 604 may also include a processor and memory media (not shown) in certain embodiments. A processor and memory included with network element 102, such as processor 608 and memory media 610 or another processor and memory media, may implement at least certain portions of the methods for managing software keys for network elements, as described herein. For example, processor 608 and memory media 610 may implement methods 500 and 501 for managing software keys at a network element, described above with respect to FIGS. 5A, 5B, and 5C.

In FIG. 6, network element 102-1 is shown including at least one network interface 604, which provides a plurality of ports 606 that receive a corresponding transmission media 12 (see also FIG. 1). Ports 606 and transmission media 12 may represent galvanic or optical network connections. Each network interface 604 may include any suitable system, apparatus, or device configured to serve as an interface between network element 102-1 and transmission medium 12. Each network interface 604 may enable network element 102-1 to communicate with other network elements 102 using any of a variety of transmission protocols and/or standards. Network interface 604 and its various components may be implemented using hardware, software, or any combination thereof.

In network element system 600, network interfaces 604 may represent various types of physical devices and interfaces. For example, network interfaces 604 may be implemented in an extendable manner to provide various types of network interfacing functionality. For example, network interfaces 604 may represent shelves that accommodate a plurality of interface cards, which, in turn, provide a plurality of ports 606. In some embodiments, a shelf represented by network interface 604 may be populated with a certain type of interface card, such as for optical networking or for electrical (galvanic) networking. In certain embodiments, network interfaces 604 themselves may represent a network interface card. In various embodiments, network interfaces 604 may represent a line card. Each port 606 may include a system, device or apparatus configured to serve as a physical interface between corresponding transmission medium 12 and network interface 604. In some embodiments, port 606 may comprise an Ethernet port. Although in FIG. 6 network interfaces 604 are shown with 2 instances of ports 606 for descriptive clarity, in different embodiments, network interfaces 604 (or cards included with network interfaces 604) may be equipped with different numbers of ports 206 (e.g., 4, 6, 8, 16 ports, etc.). In various embodiments, network element 102-1 may be configured to receive data and route such data to a particular network interface 604 or port 606 based on analyzing the contents of the data, such as information in a data packet comprising the data. When network interface 604 is an optical networking interface, network element 102-1 may receive and route data based on a characteristic of an optical signal carrying the data (e.g., a wavelength or a modulation format of the signal). In certain embodiments, network element 102-1 may include a switching element (not shown) that may include a switch fabric (SWF).

As disclosed herein, methods and systems for managing software keys include distributing software keys from a vendor to a customer key manager at a secure customer network that includes network elements comprising a transport network operated by a customer. Responsive to a provisioning event involving a network element, the network element may request a software key from the customer key manager for a network service associated with the provisioning event. The customer key manager may manage the software keys issued to network elements within the secure customer network. The software key may be provided as a key file that may be encrypted.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A method for distributing software keys to network elements, the method comprising:
receiving, at a key manager, a request for a software key from a network element, wherein the software key is associated with a software license provided by a vendor for the network element;
validating that the software key is available for the network element;
generating a key file including the software key, wherein the key file includes a globally unique identifier associated with the network element;
recording, in a key repository accessible to the key manager, a key-used indication that the software key was used in the key file;
enabling the key file to be sent to the network element; and
receiving a confirmation that the software key was used at the network element.

2. The method of claim 1, wherein the globally unique identifier includes at least one of:
a processor identifier for a processor included in the network element;
a universal serial identifier associated with the network element; and
a universal serial identifier associated with a subcomponent of the network element.

3. The method of claim 2, wherein validating that the software key is available for the network element includes:
determining that the software key is not available for the network element; and
requesting that the software key is obtained from the vendor.

4. The method of claim 1, further comprising:
encrypting the software key prior to enabling the key file to be sent to the network element.

5. The method of claim 4, wherein encrypting the software key further comprises:
encrypting the software key using a public key of a public/private encryption key pair, wherein a private key of the public/private encryption key pair is associated with the network element, and wherein the public/private encryption key pair is generated using at least a portion of the globally unique identifier.

6. The method of claim 1, further comprising:
receiving, at the key manager, a notification from the network element that the software license is no longer in use;
responsive to the notification, recording, in the key repository, a key-available indication that the software key is available for use, wherein the key-used indication is removed.

7. A method for managing software keys at network elements, the method comprising:
responsive to a provisioning event for a network service at a network element in a transport network, determining that the network service is subject to a software license associated with the network element;
sending a first request to a key manager for a software key associated with the software license;
responsive to the first request, receiving a key file including the software key, wherein the key file includes a globally unique identifier associated with the network element;
validating that the software key is issued for the network element; and
activating the software license for the network service.

8. The method of claim 7, further comprising:
responsive to the first request, receiving a key-declined indication that the software key is not available from the key manager; and
responsive to the key-declined indication:
enabling the network service on the network element; and
when the network service is enabled, generating a network alarm on the transport network indicating that the software license is pending, wherein the network alarm is repeated periodically until the key file is received.

9. The method of claim 8, further comprising:
repeating the network alarm over a predetermined period, wherein a priority of the network alarm is increased over the predetermined period, and wherein the predetermined period is indicated in the network alarm; and
when the software key is not received at the network element within the predetermined period, disabling the network service on the network element when the predetermined period is elapsed.

10. The method of claim 8, further comprising:
responsive to the key-declined indication:
disabling the network service on the network element.

11. The method of claim 7, wherein the provisioning event de-provisions the network service, and further comprising:
responsive to the provisioning event, determining that the software license for the network service is no longer in use; and
sending a second request to remove the software key to the key manager.

12. The method of claim 7, wherein determining that the network service is subject to a software license associated with the network element further comprises:
accessing a policy file at the network element to determine whether the network service is subject to the software license, wherein the policy files includes software license terms for a plurality of network services, including the network service.

13. The method of claim 12, further comprising:
performing an update of the policy file, including receiving a new policy file.

14. The method of claim 7, wherein the software license is selected from at least one of:
a global license for the transport network, the transport network including the network element;
a license for the network element;
a license for a subcomponent of the network element;
a license to increase data throughput at the network element;
a license to increase a number of ports used at the network element;
a license to introduce the network service at the network element; and
a license to increase a number of instances of the network service used at the network element.

15. The method of claim 7, wherein the network service is selected from at least one of:
a protection switching network service;
a link access group network service;
an optical unidirectional path-switched ring network service;
a network service to use a wavelength selective switch;
a network service to increase a number of ports at a wavelength selective switch;
a network service to allow multi-traffic traffic identifiers per shelf of reconfigurable optical add drop multiplexer;
a network service to increase a capacity of a card;
a network service to increase a capacity of a shelf;
a network service to increase capacity of a time-domain multiplexing switch;
a network service to enable optical transport network switching;
a network service to mix different optical transport networking cards within a shelf;
a network service at an optical transport network control plane; and
a network service to enable selection of revertive or non-revertive protection switching.

16. The method of claim 7, wherein the software key is encrypted using a public key of a public/private encryption key pair, and wherein validating that the software key is issued for the network element further comprises:
decrypting the software key using a private key of the public/private encryption key pair, wherein the public/private encryption key pair is generated using at least a portion of the globally unique identifier.

17. A network element, comprising:
a processor having access to memory media, wherein the memory media store processor-executable instructions that, when executed by the processor, cause the processor to:
responsive to a provisioning event for a network service in a transport network including the network element, determine that the network service is subject to a software license associated with the network element;
send a request to a key manager for a software key associated with the software license;
responsive to the request, receive a key file including the software key, wherein the key file includes a globally unique identifier associated with the network element;
validate that the software key is issued for the network element; and
activate the software license for the network service.

18. The network element of claim 17, further comprising instructions to:
responsive to the request, receive a key-declined indication that the software key is not available from the key manager; and
responsive to the key-declined indication:
enable the network service on the network element; and
when the network service is enabled, generate a network alarm on the transport network indicating that the software license is pending, wherein the network alarm is repeated periodically until the key file is received.

19. The network element of claim 18, further comprising instructions to:
repeat the network alarm over a predetermined period, wherein a priority of the network alarm is increased over the predetermined period, and wherein the predetermined period is indicated in the network alarm; and
when the software key is not received at the network element within the predetermined period, disable the network service on the network element when the predetermined period is elapsed.

20. The network element of claim 17, further comprising instructions to:
responsive to the key-declined indication:
disable the network service on the network element.

21. The network element of claim 17, wherein the provisioning event de-provisions the network service, and further comprising instructions to:
responsive to the provisioning event, determine that the software license for the network service is no longer in use; and
send a second request to remove the software key to the key manager.

22. The network element of claim 17, wherein the instructions to determine that the network service is subject to a software license associated with the network element further comprise instructions to:
access a policy file at the network element to determine whether the network service is subject to the software license, wherein the policy files includes software license terms for a plurality of network services, including the network service.

23. The network element of claim 19, further comprising instructions to:
perform an update of the policy file, including instructions to receive a new policy file.

24. The network element of claim 17, wherein the software license is selected from at least one of:
a global license for the transport network, the transport network including the network element;
a license for the network element;
a license for a subcomponent of the network element;
a license to increase data throughput at the network element;
a license to increase a number of ports used at the network element;
a license to introduce the network service at the network element; and
a license to increase a number of instances of the network service used at the network element.

25. The network element of claim 17, wherein the network service is selected from at least one of:
a protection switching network service;
a link access group network service;
an optical unidirectional path-switched ring network service;
a network service to use a wavelength selective switch;
a network service to increase a number of ports at a wavelength selective switch;
a network service to allow multi-traffic traffic identifiers per shelf of reconfigurable optical add drop multiplexer;
a network service to increase a capacity of a card;
a network service to increase a capacity of a shelf;
a network service to increase capacity of a time-domain multiplexing switch;
a network service to enable optical transport network switching;
a network service to mix different optical transport networking cards within a shelf;
a network service at an optical transport network control plane; and
a network service to enable selection of revertive or non-revertive protection switching.

26. The network element of claim 17, wherein the software key is encrypted using a public key of a public/private encryption key pair, and wherein the instructions to validate that the software key is issued for the network element further comprise instructions to:
decrypt the software key using a private key of the public/private encryption key pair, wherein the public/private encryption key pair is generated using at least a portion of the globally unique identifier.
